(19) United States
(12) Patent Application Publication
(10) Pub. No.: US 2016/0004123 A1
(43) Pub. Date: Jan. 7, 2016

(54) IMAGE DISPLAY APPARATUS

(71) Applicants: Kabushiki Kaisha Toshiba, Tokyo (JP); Toshiba Lifestyle Products & Services Corporation, Tokyo (JP)

(72) Inventor: Harumi Tanabe, Hamura-shi (JP)

(21) Appl. No.: 14/585,015

(22) Filed: Dec. 29, 2014

Related U.S. Application Data
(60) Provisional application No. 62/020,157, filed on Jul. 2, 2014.

(51) Int. Cl. G02F 1/1335

(52) U.S. Cl. CPC G02F 1/133603; G02F 1/133605; G02F 1/133606; G02F 1/133608

(57) ABSTRACT

According to one embodiment, an image display apparatus including, a display which displays information, a light source includes a plurality of LED elements and a covers each covers each of the respective LED elements, a reflective member including a plurality of openings through which the light source is exposed, and which reflects illumination light from the LED elements, and a light control member, formed around each of the openings and being provided with a predetermined width in a radial direction of the openings, to control the reflection of the illumination light from each of the LED elements being reflected from the reflective member wherein the width of the light control member being less than half a center-to-center distance between the openings.

### CROSS-REFERENCE TO RELATED APPLICATIONS

This application claims the benefit of U.S. Provisional Application No. 62/020,157, filed Jul. 2, 2014, the entire contents of which are incorporated herein by reference.

### FIELD

Embodiments described herein relate generally to an image display apparatus.

### BACKGROUND

An image display apparatus has a liquid crystal display (LCD) panel and a backlight unit. The backlight unit illuminates an image displayed on the LED panel.

The backlight unit comprises an arbitrary number of light emitting diode (LED) elements, which may be controlled based on features such as a size and a shape (for example, an aspect ratio) of a display area of the LCD panel. The backlight unit further comprises a diffuser panel or an optical sheet which diffuses light output by the LED elements and a reflective sheet which reflects a part of the light output by the LED elements, together with a circuit board which supports the LED elements.

A predetermined number of LED elements are generally arranged in a first direction and a second direction orthogonal to the first direction, respectively.

However, since light obtained by diffusing the direct light from the LED elements with the diffuser panel or the optical sheet partially coincides with reflected light from the reflective sheet differing from the direct light, uniform luminance can barely be obtained in the whole of the display area of the LED panel. That is, a problem that uneven brightness (irregularity of luminance) occurs on the image displayed on the LED panel still is not solved completely.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of an image display apparatus according to an embodiment;

FIG. 2 is an exemplary diagram showing an example of a backlight unit of the image display apparatus according to an embodiment;

FIG. 3 is an exemplary diagram showing an example of a backlight unit of the image display apparatus according to an embodiment;

FIG. 4 is an exemplary diagram showing an example of a backlight unit of the image display apparatus according to an embodiment;

FIG. 5 is an exemplary diagram showing an example of a backlight unit of the image display apparatus according to an embodiment;

FIG. 6 is an exemplary diagram showing an example of a backlight unit of the image display apparatus according to an embodiment;

FIG. 7 is an exemplary diagram showing an example of a backlight unit of the image display apparatus according to an embodiment;

FIG. 8 is an exemplary diagram showing an example of a backlight unit of the image display apparatus according to an embodiment; and

FIG. 9 is an exemplary diagram showing an example of a backlight unit of the image display apparatus according to an embodiment.

### DETAILED DESCRIPTION

Various embodiments will be described hereinafter with reference to the accompanying drawings.

In general, according to one embodiment, an image display apparatus comprising, a display which displays information, a light source includes a plurality of LED elements and covers each covers each of the respective LED elements, a reflective member including a plurality of openings through which the light source is exposed and which reflects illumination light from the LED elements, and a light control member, formed around each of the openings and being provided with a predetermined width in a radial direction of the openings, to control the reflection of the illumination light from each of the LED elements being reflected from the reflective member. The width of the light control member is less than half a center-to-center distance between the openings.

Embodiments will now be described hereinafter in detail with reference to the accompanying drawings.

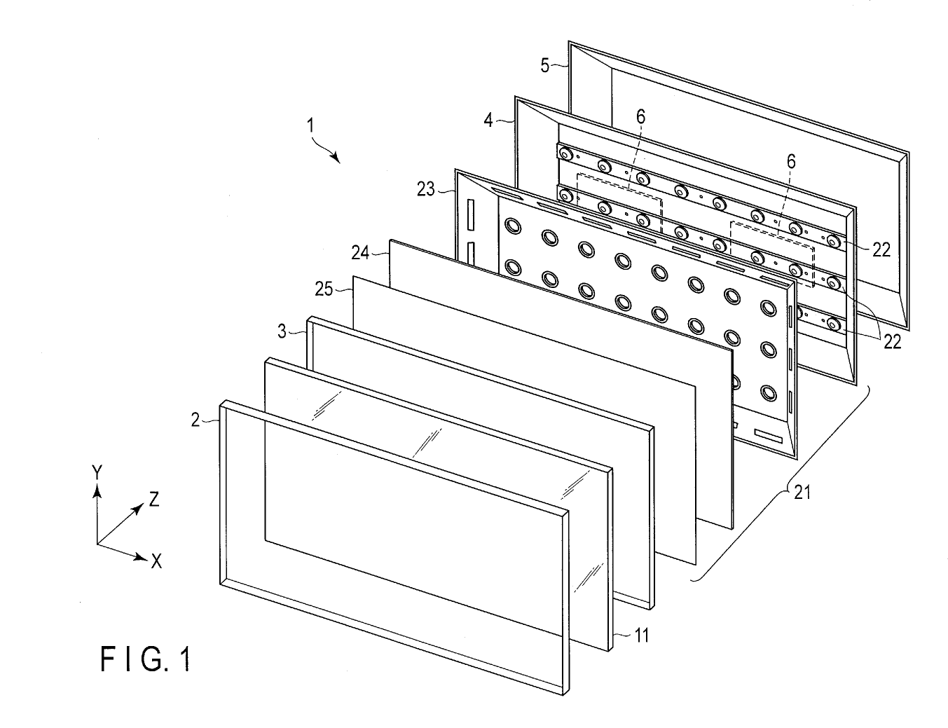

FIG. 1 shows an example of main elements of an image display apparatus (a television broadcast receiving apparatus, hereinafter referred to as a television device).

The television device 1 comprises a liquid crystal display (LCD) panel (hereinafter referred to as a display panel) 11 to display an image, and a backlight unit 21 to illuminate the image displayed on the display panel 11.

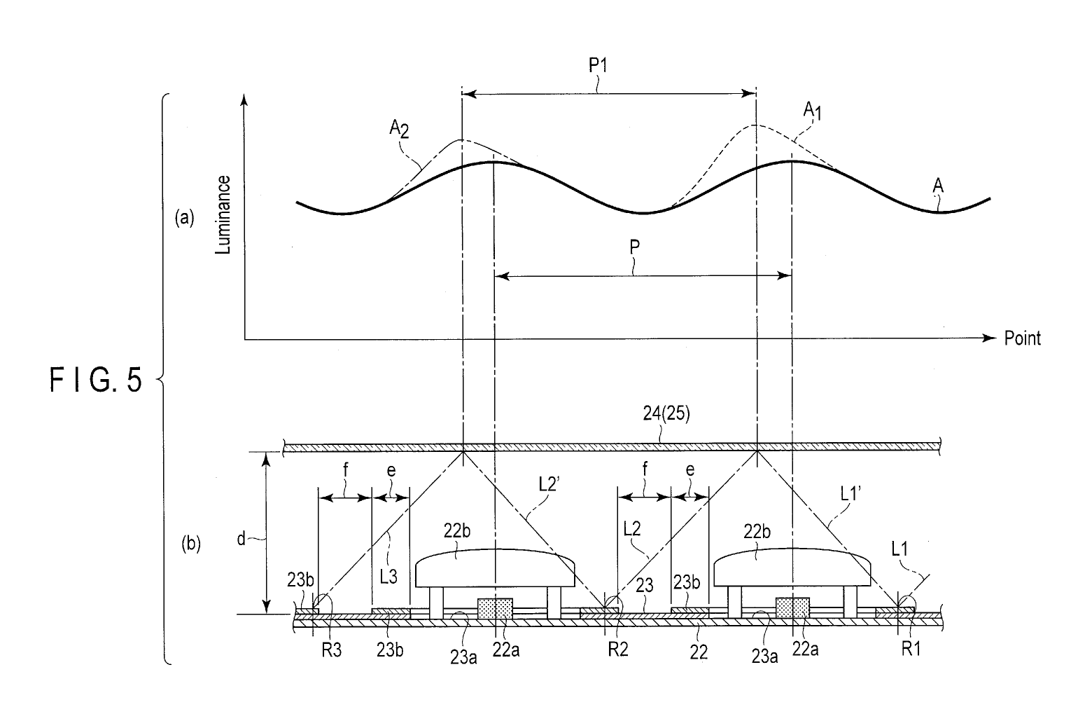

The backlight unit 21 comprises a plurality of LED bars (light source members) 22 each including an arbitrary number of light emitting diode (LED) elements, a back bezel 4 supporting the LED bars 22 and integrated with a reflective sheet 23, a diffuser panel 24, and an optical sheet 25. Each of the LED bars 22 includes a predetermined number of LED elements positioned at predetermined intervals on a base material extending in the first direction. A predetermined number of LED bars 22 are arranged parallel to the first direction. Each of the LED elements, which are shown in an expanded view of FIG. 5, comprises an LED chip 22a and a lens 22b which diffuses light output by the LED chip 22a. The reflective sheet 23 reflects light, which is output by each of the LED elements included in the LED bars 22 and reflected from the diffuser panel 24, the optical sheet 25, or an arbitrary point on the backlight unit 21 such as a side surface of the lens 22b or a surface of the lens 22b on the side of the LED bars 22, toward the diffuser panel 24 or the optical sheet 25, i.e., the display panel 11. The reflective sheet 23 is a light-scattering material arranged to face the side of the display panel 11 when the reflective sheet 23 is installed in the TV apparatus 1. Instead of the light-scattering material, the reflective sheet 23 may be realized by, for example, providing a thin film of a member having high optical reflectance on a surface of a base material, performing high luminance processing or mirror finishing for the thin film, and processing the thin film into a diffusing surface by frosting, etc. The arrangement sequence of the diffuser panel 24 and the optical sheet 25 from the side of the reflective sheet may be reversed. A plurality of optical sheets 25 may be provided.

A front bezel 2 is positioned at a predetermined position on a front surface (i.e., the opposite side of the backlight unit 21 in the front-back direction based on the position of the display panel 11) of the display panel 11. The front bezel 2 defines the position of a display surface of the display panel 11 (an image output surface of the display panel 11) in a surface orthogonal to the front-back direction of the TV apparatus 1 in which all the components are assembled.

A middle frame 3 is positioned at a predetermined position between the display panel 11 and the backlight unit 21 in the front-back direction. The middle frame 3 defines positions of the display panel 11 and the backlight unit 21 (i.e., sets a position of the display panel 11 with respect to the backlight unit 21).

The back bezel 4 supports the middle frame 3 (i.e., the display panel 11 supported by the middle frame 3).

A back cover 5 is positioned on the back surface of the back bezel 4. The back bezel 4, i.e., the display panel 11 and the backlight unit 21 are supported between the back cover 5 and the front bezel 2. An arbitrary number of circuit boards 6 such as a control circuit, an image processing circuit, a power source drive circuit, a power supply circuit, etc., are positioned between the back cover 5 and the back bezel 4. Each of the circuit boards 6 is positioned at a predetermined position of the back bezel 4 in the embodiment. The control circuit controls operations of the TV apparatus 1. The image processing circuit processes image signals displayed on the display panel 11. The light source drive circuit controls illumination of the display panel 11 by the backlight unit 21. The power supply circuit supplies power to each element of the TV apparatus 1. A stand used when the TV apparatus 1 is placed on, for example, a desk, may be attached to the back cover 5.

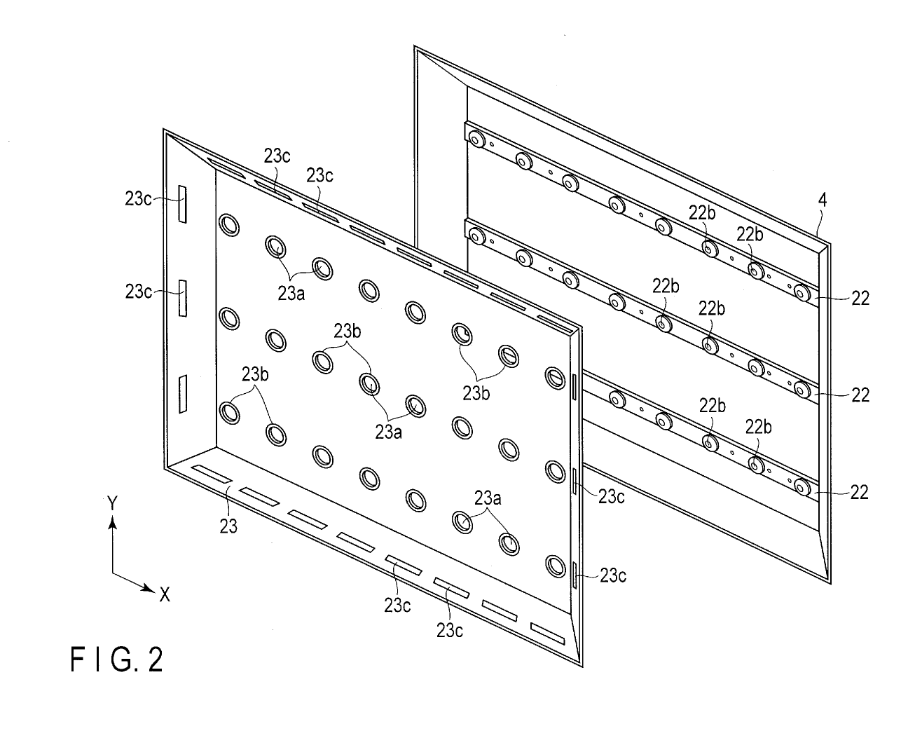

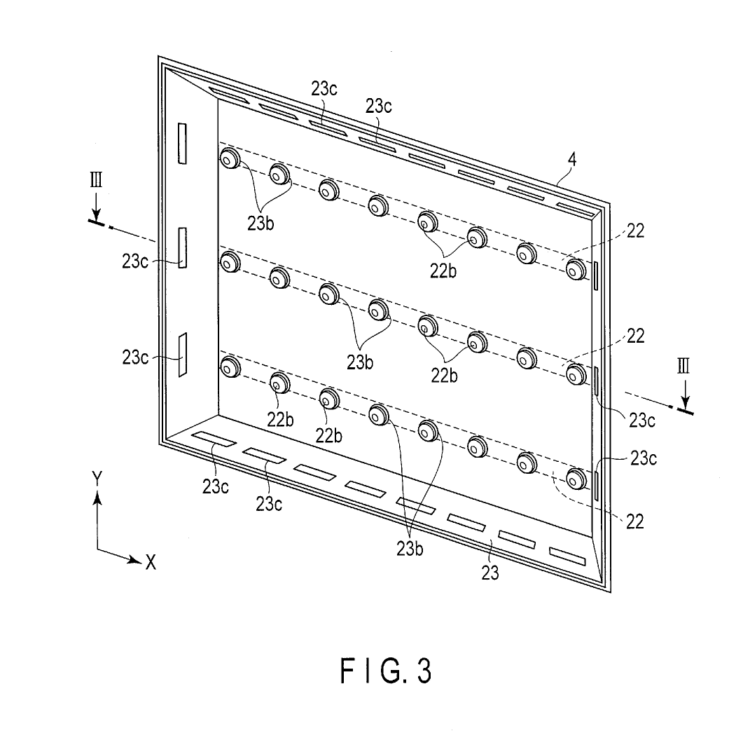

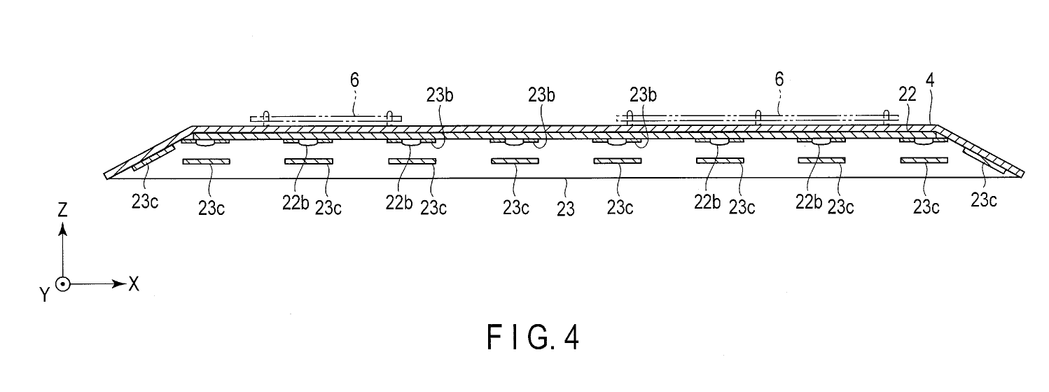

FIG. 2 shows a state where the back bezel into which the LED bars of the backlight unit are incorporated is separated from the reflective sheet. FIG. 3 shows a state where the back bezel is integrated with the reflective sheet. FIG. 4 is a cross-sectional view of the back bezel and the reflective sheet shown in FIG. 3 seen along line III-III.

As shown in FIG. 2 and FIG. 3, the reflective sheet 23 has a plurality of apertures (openings) 23a, . . . , 23a. The openings 23a, . . . , 23a expose the respective lenses 22b of the LED elements of the LED bars 22 supported by the back bezel 4 to the side of the inner surface (the side facing the display panel when the TV apparatus 1 is assembled) of the reflective sheet 23. The lens 22b of each LED element may be a cover which sets a cross section of the light from the LED chip 22a to a predetermined shape. The shape of the lens (or cover) 22b seen from the planar direction is optional and may be, for example, a rectangle, a square, an ellipse, etc., in addition to a circle. Thus, the shape of each of the openings 23a, . . . , 23a should be preferably similar to the shape of the lens (or cover) 22b of each LED element.

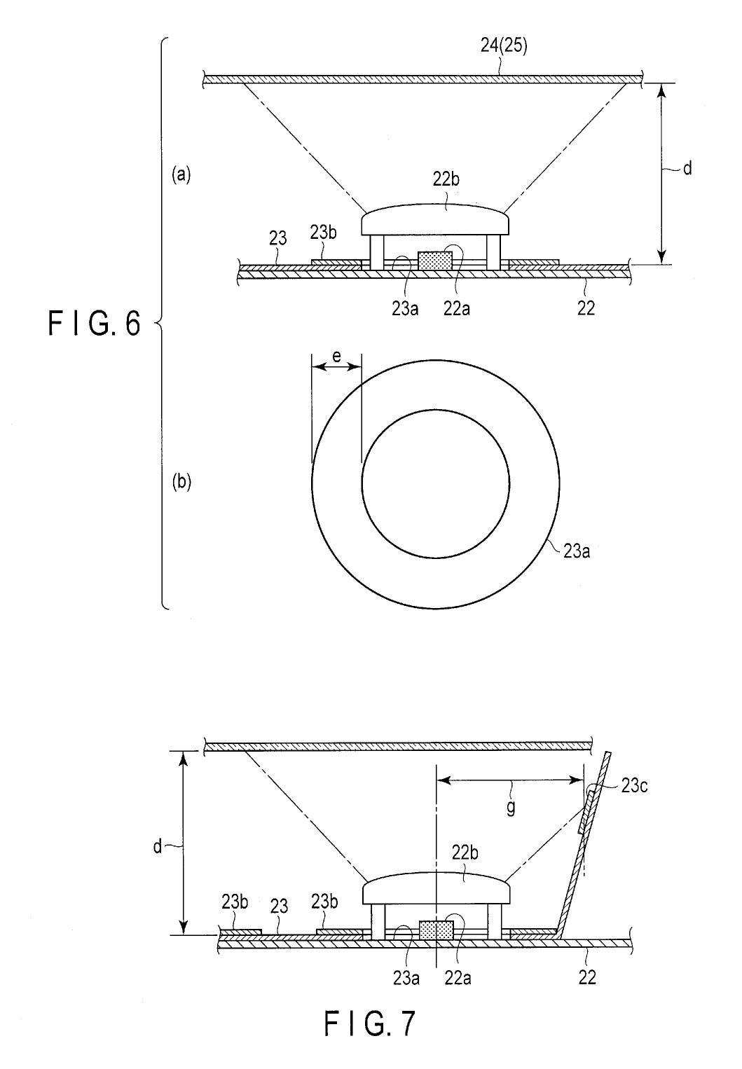

Antireflection members 23b, . . . , 23b, which will be described in detail with reference to FIG. 5, are positioned at the outer peripheries of the respective apertures (openings) 23a, . . . , 23a of the reflective sheet 23 to reduce reflection of the light from each LED element or illumination light reflected from an arbitrary point on the reflective sheet 23, the diffuser panel 24 or the optical sheet 25 and returned to the reflective sheet 23. Second antireflection members 23c, . . . , 23c, which will be described in detail with reference to FIG. 4 and FIG. 7, are positioned at predetermined positions of the reflective sheet 23 to prevent light which has passed through the lens 22b of the LED element from reflecting on the reflective sheet 23 before the light reaches the diffuser panel 24 or the optical sheet 25. It is needless to say that the shape of each of the antireflection members 23b, . . . , 23b is similar to the shape of the lens (cover) 22b of the LED element. It is assumed that a width e of each of the antireflection members 23b, . . . 23b shown in FIG. 5 or FIG. 6 is defined in the widest (thickest) area.

The light output by each LED element of the LED bars 22 is reflected from a surface (optical incidence surface) of an optical member such as the diffuser panel 24 or the optical sheet 25, and is returned to the side of the LED bars 22. The light (the return light) which is returned to the side of the LED bars 22 is approximately 30 to 40% of the light output by the LED elements. The return light is reflected from a reflection surface (a printed circuit board [PCB] surface serving as a structure of the LED bar or a resist pattern [print area] positioned on the PCB surface, and a reflective sheet) and is returned to the diffuser surface, etc. The return light, which will be described in a subsequent stage with reference to FIG. 5, overlaps with the primarily required light reflected from the reflective sheet. The luminance of an area where the return light overlaps is thereby partially increased. The return light often causes variation of luminance distribution and variation of color since the return light may give different spectral distribution from the light output by the LED elements.

An element similar to the antireflection members 23b, . . . , 23b may be positioned at a resist print area, etc., on a substrate (a part of the structure of the LED bars) between the LED bars 22 and a lens of each LED element of the LED bar 22.

The antireflection members 23b, . . . , 23b and the second antireflection members 23c, . . . , 23c can be realized by various methods such as coating using a black paint, a stamp of black ink or pigment, or black silk-screen printing. When the antireflection members 23b, . . . , 23b and the second antireflection members 23c, . . . , 23c are realized by a paint, the paint should be preferably a matte paint. The antireflection members 23b, . . . , 23b and the second antireflection members 23c, . . . , 23c may be, for example, stickers applied with black or matte-black color material. At least a part of the area of the antireflection members 23b, . . . , 23b and the second antireflection members 23c, . . . , 23c may be different from the other parts in density. That is, the intensity (degree of reflection) of the reflected light can be controlled by varying the density (print density/color material density) of the antireflection members 23b, . . . , 23b.

The antireflection members 23b, . . . , 23b and the second antireflection members 23c, . . . , 23c may, for example, absorb light of a predetermined wavelength. In this case, the color of the antireflection members 23b, . . . , 23b/23c, . . . , 23c may be different from black.

The antireflection members 23b, . . . , 23b will be hereinafter described with reference to FIG. 5 are reduce the intensity of light L1 directed to an arbitrary point (point of reflection) R1 on the reflective sheet 23. Thus, the intensity of light L1′ reflected from point of reflection R1 is lower than the light intensity of light L1 directed to point of reflection R1. Light L1′ reflected from point of reflection R1 may be different from light L1 directed to point of reflection R1 in spectral distribution. The difference in spectral distribution occurs by absorption by a material of the lenses 22b of the LED elements, chromatic aberration of the lenses 22b, absorption by the antireflection members 23b, . . . , 23b provided at point of reflection R1, etc. When the antireflection members 23b, . . . , 23b are not provided, the light which has been reflected from the reflective sheet 23 and passed through the lens 22b of the LED element coincides with other light and passes through the diffuser panel 24 or the optical sheet 25. Therefore, the luminance of the illumination light which reaches the side of the display panel 21 becomes greater than the expected (essentially required) luminance A as represented by “A1” in (a) of FIG. 5. In other words, the reflection light near the LED element is absorbed by providing black print (antireflection member) on the reflective sheet, the luminance directly above and near the LED element can be accordingly decreased and the luminance uniformity can be increased.

A part of light L1′ which has passed through the lens 22b of the LED element and reached the diffuser panel 24 or the optical sheet 25 is reflected from the diffuser panel 24 or the optical sheet 25 and directed to an arbitrary point (point of reflection) R2 on the reflective sheet 23. Light L2 directed to the arbitrary point (point of reflection) R2 on the reflective sheet 23 is reflected from point of reflection R2 and becomes light L2′. The intensity of light L2′ reflected from point of reflection R2 is lower than the light intensity of light L2 directed to point of reflection R2. The spectral distribution of light L2′ reflected from point of reflection R2 may be different from the spectral distribution of light L2 directed to point of reflection R2 owing to absorption into the antireflection members 23b, . . . , 23b provided at point of reflection R2. When the antireflection members 23b, . . . , 23b are not provided, light L2′ which has been reflected from the reflective sheet 23 and passed through the lens 22b of the LED element may coincide with other light and pass through the diffuser panel 24 or the optical sheet 25. Therefore, the luminance of the illumination light which reaches the side of the display panel 21 becomes greater than the expected (essentially required) luminance A as represented by “A2” in (a) of FIG. 5. Luminance “A2” and “A1” of the illuminated light which reaches the side of the display panel 21 is not always the same. Since an interval between points of reflection R2 and R1 depends on an interval d between the diffuser panel 24 or the optical sheet 25 and the reflective sheet 23, an interval P1 between luminance “A2” and “A1” of the illumination light which reaches the side of the display panel 21 often does not correspond to an interval between the LED elements, i.e., a center-to-center distance P between the openings 23a, . . . , 23a. In addition, since the spectral distribution of the light may be varied as a consequence of the reflection from the diffuser panel 24 or the optical sheet 25, luminance “A2” and “A1” of the illumination light which reaches the side of the display panel 21 may be different in color even if the luminance is substantially the same. Therefore, when the difference in color is recognized in the illumination light which reaches the side of the display panel 21, it is preferable that a wavelength (spectrum) of the light absorbed by the antireflection members 23b, . . . , 23b is arbitrarily set as described above.

A part of light L2′ which has passed the lens 22b of the LED element and reached the diffuser panel 24 or the optical sheet 25 is hereinafter reflected from the diffuser panel 24 or the optical sheet 25 again and directed to an arbitrary point (point of reflection) R3. The light intensity of the light reflected from point of reflection R3 is less than that of the light reflected from R2 or R1, but irregularity in luminance is improved by application of the embodiment.

As exemplified in FIG. 5 and FIG. 6, each of the antireflection members 23b, . . . , 23b is a ring having an interior diameter substantially equal to or slightly greater than each of the openings 23a, . . . , 23a of the reflective sheet 23. That is, each of the antireflection members 23b, . . . , 23b has a predetermined width in a radial direction of the lens 22b of each LED element. As described above, each of the openings 23a, . . . , 23a should preferably have a shape similar to the shape of the lens (cover) 22b of the LED element. Accordingly, each of the openings 23a, . . . , 23a may be arbitrarily shaped into, for example, a circle, a rectangle, a square, an ellipse, etc., based on the shape of the lens (or cover) 22b of the LED element seen from the planar direction. The interior diameter of each of the antireflection members 23b, . . . , 23b is slightly greater than the diameter of the lens 22b of each LED element. The width e of each of the antireflection members 23b, . . . , 23b should be preferably less than the distance f between the antireflection members 23b, . . . , 23b provided for the adjacent LED elements (and the center-to-center distance between the openings 23a, . . . , 23a provided with the antireflection members 23b, . . . , 23b) so as not to reduce the light to be reflected more than necessary. However, the width e of each of the antireflection members 23b, . . . , 23b can be arbitrarily set in accordance with the relationship with the intensity of the light to be reflected, and can be, for example, half the center distance between the openings 23a, . . . , 23a (in this case, f is zero).

As exemplified in FIG. 6, the width e of each of the antireflection members 23b, . . . , 23b is set to be, for example, less than or equal to half, for example, the distance d between the reflective sheet 23 and the diffuser panel 24 or the optical sheet 25 so as not to reduce the light to be reflected from the reflective sheet 23 more than necessary.

The degree of reflection (intensity of reflection light) of each of points of reflection R1, R2, R3, . . . , can be controlled by varying the density (print density/color material density) of the point.

The vicinity of the outer periphery of the width e of each of the antireflection members 23b, . . . , 23b should preferably have a concentration gradient (gradation). The gradation can prevent rapid variation of the degree of reflection (luminance difference) between reflection from the reflective members 23b, . . . , 23b and reflection from the body of the reflective sheet 23. The diameter of the outermost periphery of the gradation is excluded from the definition of the width e described above (i.e., the above-described relationship between the width e and the distance d from the reflective sheet 23 to the diffuser panel 24 or the optical sheet 25 is not applied to the outermost periphery of the gradation).

FIG. 7 shows a positional relationship between the second antireflection members 23c, . . . , 23c and the reflective sheet 23.

As shown in FIG. 7, illumination light output by the LED elements of the LED bars 22 positioned at a distance less than a predetermined distance from the reflective sheet 23 reaches a wall surface of the reflective sheet 23 before reaching the diffuser panel 24 or the optical sheet 25. For example, an LED element at the longitudinal end of the LED bar 22 extending in the first direction is positioned at a distance less than the predetermined distance from the reflective sheet 23. Alternatively, LED elements on an LED bar 22, which is positioned at a distance less than the predetermined distance from the reflective sheet 23, of a plurality of LED bars 22 arranged parallel to the first direction are positioned at a distance less than the predetermined distance from the reflective sheet 23.

In the example of FIG. 7, a part of the illumination light which reaches the diffuser panel 24 or the optical sheet 25 coincides with light reflected from a side surface (sidewall portion) of the reflective sheet 23. Accordingly, the luminance of the illumination light which reaches the side of the display panel 21 is varied similarly to the example of FIG. 5. Therefore, luminance distribution of the illumination light which reaches the side of the display panel 21 should be preferably optimized by the second antireflection members 23c, . . . , 23c.

The second antireflection members 23c, . . . , 23c can be arbitrarily shaped into, for example, an ellipse, an oval, a rectangle (oblong), a trapezoid or a polygon, if the variation (dispersion) of the luminance distribution seen from the side of the display panel can be confined within a predetermined range.

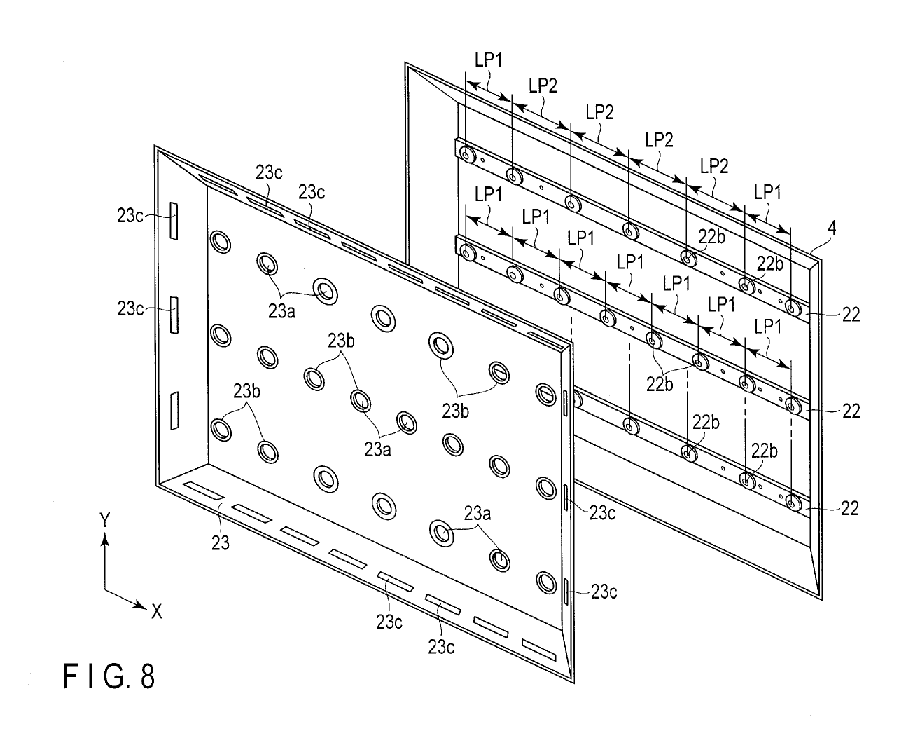

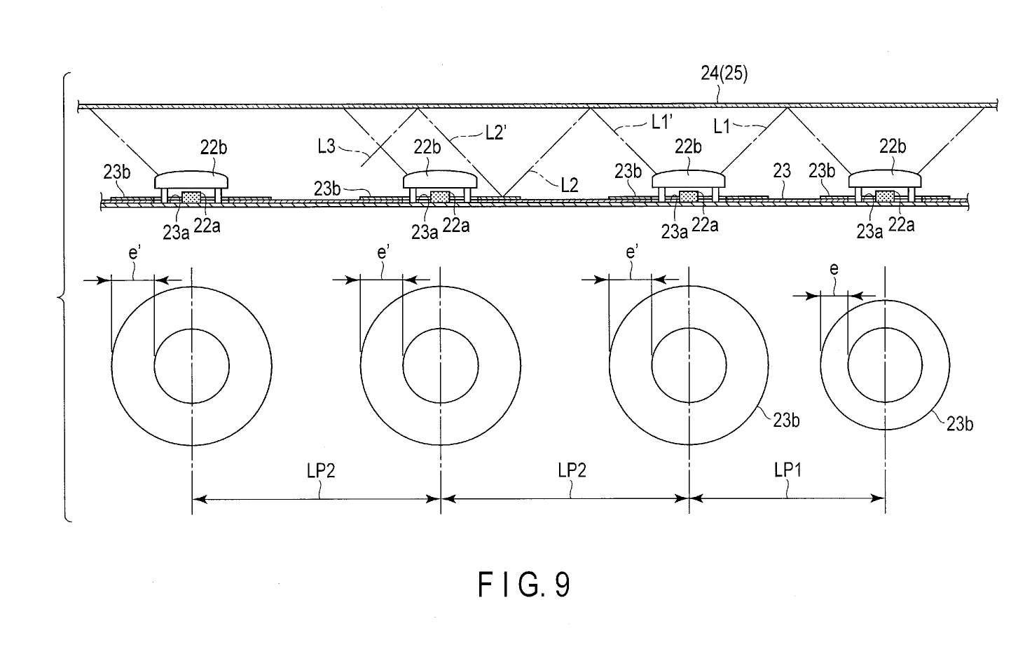

FIG. 8 and FIG. 9 show an example of the backlight unit using LED bars holding LED elements arranged at different intervals. FIG. 8 shows a state where the LED bars are not yet incorporated into the reflective sheet and FIG. 9 shows an example of a relationship between intervals LP1 and LP2 of the LED bar and a width between the antireflection members 23b, . . . , 23b positioned on the reflective sheet.

As shown in FIG. 8, in the backlight unit where LED bars having LED elements arranged with different intervals are mixed, intervals between the LED elements are classified into a first interval LP1 and a second interval LP2 wider than the first interval LP1. The center-to-center distance between the openings 23a, . . . , 23a is substantially the same as the interval between the LED elements.

Therefore, when the center-to-center distance between the openings 23a, . . . , 23a (interval between the LED elements) is the second interval LP2, the reflection light L2 reflected from the diffuser panel 24 or the optical sheet 25 is reflected from the reflective sheet 23 and directed to the diffuser panel 24 or the optical sheet 25 without passing through the lens 22b of the LED element as shown in FIG. 9. Accordingly, a width e′ of each of the antireflection members 23b, . . . , 23b is defined to be wider than those in the case where the interval between the LED elements (openings) is the first interval LP1. When the interval between the LED elements is the second interval LP2 wider than the first interval LP1, the width e′ of each of the antireflection members 23b, . . . , 23b provided on the reflective sheet 23 should be preferably e×LP2/LP1. However, the width e′ of each of the antireflection members 23b, . . . , 23b may be equal to the width e. As shown in FIG. 9, when the center-to-center distance between the openings 23a, . . . , 23a (interval between the LED elements) is LP2, the width of the antireflection member 23b should be preferably e′ even in the opening 23a positioned with the first interval LP1 from the adjacent opening 23a. That is, the degree of reflection can be controlled within a wider range if the width of the antireflection member 23b is e′ when the interval is LP2.

The antireflection members of the present embodiment control reflection of unnecessary reflection light which may become a factor for dispersion of luminance distribution and variation of color when seen from the side of the display panel. As described above, the degree of dispersion of luminance and color shading of an extensive range and various types of LED lighting can be set to fall within a predetermined range by providing the antireflection members on the reflective sheet. In addition, bright sections (hot spots) made by reflection of light from LED lighting can be reduced by providing the antireflection members at predetermined areas of a rising portion of the side surface of the reflective sheet.

Since light diffusion characteristics of the reflective sheet can be set more variously than the resist print area provided on the base material of the LED bars, a boundary between an area with black print (antireflection member) and an area without black print can be obfuscated (i.e., unnaturalness of the boundary can be reduced). The uniformity of the luminance distribution can be thereby increased.

Since the reflection of unnecessary reflection light which becomes a factor for dispersion of luminance distribution and variation of color is controlled by the antireflection members provided on the reflective sheet, the period of design and the cost of development can be reduced more than the case of changing characteristics of the lens of the LED element.

The reflection of unnecessary reflection light which becomes a factor for dispersion of luminance distribution and variation of color can be controlled by the antireflection members, and the number of the LED elements can be thereby reduced. The same LED bars can be applied (used) to various types of image display apparatuses by changing a pattern of the antireflection members. The cost of the backlight unit (the LED bars and the reflective sheet) can be thereby cut.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments can be also realized in the following structures.

In the case where a broadcast receiver having a network function is provided with a game function by a cloud gaming, the broadcast receiver is provided with a function for automatically changing display and audio output so as to prioritize performance without having the user set the function at the time of execution of the game. Thus, users receive the benefit of convenience.

Device information of a client is reported to a server application. This allows provision of a settlement function which is suitable for the device and/or environment. The server application provides a structure which can be applied in common with a terminal.

In the case where the device is a broadcast receiver, the broadcast receiver is only provided with verification by a settlement account by email, or transmission of homepage address for the Internet settlement to another information processor by email. In the case of an information processor, the information processor is provided with both the function of credit information input settlement and the function of settlement account.

In the case where a keyboard is connected to a broadcast receiver, the broadcast receiver is provided with both the function of credit information input settlement and the function of settlement account.

In the case where a broadcast receiver can be remotely handled from a terminal device such as a tablet, the broadcast receiver is provided with both the function of credit information input settlement and the function of settlement account.

In the case where a contactless terminal device is connected to a broadcast receiver, the broadcast receiver further has a contactless settlement function.

What is claimed is:

1. An image display apparatus comprising:
a display which displays information;
a light source includes a plurality of LED elements and a covers each covers each of the respective LED elements;
a reflective member including a plurality of openings through which the light source is exposed, and which reflects illumination light from the LED elements; and
a light control member, formed around each of the openings and being provided with a predetermined width in a radial direction of the openings, to control the reflection of the illumination light from each of the LED elements being reflected from the reflective member,
wherein the width of the light control member being less than half a center-to-center distance between the openings.

2. The image display apparatus of claim 1, wherein the light control member reduces a degree of reflection of the illumination light from each of the LED elements of the light source.

3. The image display apparatus of claim 2, wherein the light control member includes a member capable of selectively absorbing a spectrum to prevent variation of spectral distribution of the illumination light from each of the LED elements of the light source.

4. The image display apparatus of claim 2, wherein an area of the light control member is varied according to the center-to-center distance between the openings.

5. The image display apparatus of claim 4, wherein the light control member includes a member capable of selectively absorbing a spectrum to prevent variation of spectral distribution of the illumination light from each of the LED elements of the light source.

6. An image display apparatus comprising:
a display to display information;
a light source constituted by a plurality of LED elements and a cover which covers each of the respective LED elements;
a reflective member having a plurality of openings through which the light source is exposed, and configured to reflect illumination light from the LED elements; and
a light control member, formed around each of the openings and being provided with a predetermined area, to control the illumination light from each of the LED elements being reflected from the reflective member and to reflect the reflected light, an area of the light control member around each of the openings positioned with an interval greater than a predetermined distance being greater than the predetermined area when a center-to-center distance between the openings is greater than the predetermined distance.

7. The image display apparatus of claim 6, wherein the light control member reduces a degree of reflection of the illumination light from each of the LED elements of the light source.

8. The image display apparatus of claim 7, wherein the light control member includes a member capable of selectively absorbing a spectrum to prevent variation of spectral distribution of the illumination light from each of the LED elements of the light source.

9. The image display apparatus of claim 6, wherein if the center-to-center distance B between the openings of the light control member is greater than the predetermined distance A, a width of the light control member which sets the area of the light control member is B/A as great as a width obtained when the distance B is less than or equal to the distance A.

10. The image display apparatus of claim 9, wherein the light control member reduces a degree of reflection of the illumination light from each of the LED elements of the light source.

11. The image display apparatus of claim 10, wherein the light control member includes a member capable of selectively absorbing a spectrum to prevent variation of spectral distribution of the illumination light from each of the LED elements of the light source.
